(19) United States
(12) Patent Application Publication
(10) Pub. No.: US 2005/0219340 A1
(43) Pub. Date: Oct. 6, 2005

(54) Actinic ray curable ink composition, image forming method and ink-jet recording apparatus using the same

(75) Inventor: Toshiyuki Takabayashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/092,854

(22) Filed: Mar. 30, 2005

(30) Foreign Application Priority Data
Apr. 6, 2004 (JP) JP2004-111883

(51) Int. Cl. G01D 11/00

(52) U.S. Cl. 347/100; 347/95

(57) ABSTRACT

An actinic ray curable ink composition, containing: (a) a photoinitiator; and (b) a photopolymerizable compound, wherein the photoinitiator is an onium compound exhibiting a hydrophobicity value (log P_{(O/W)}) of less than 1.0, P_{(O/W)} being a partition coefficient of the onium compound between 1-octanol and water.

### TECHNICAL FIELD

The present invention relates to an actinic ray curable ink composition which can stably produce a high-definition image on various recording materials under different recording conditions. The present invention also relates to an image forming method and an ink-jet recording apparatus using the same ink composition.

### BACKGROUND

Recently, the ink-jet recording has been applied to various printing fields such as photography, various kinds of printings, and especially printing such as marking and color filters because the ink-jet recording method can produce an image simply and at low cost.

Particularly, an image quality almost equal to a silver halide photograph can be obtained by means of: (i) a recording apparatus which enables to jet and to control a fine dot; (ii) an ink having improved properties of color reproduction area, durability, and jetting property; and (iii) an exclusive use sheet in which the absorptivity of the ink, coloring property of the coloring material, surface glossiness are greatly increased.

The increase of the image quality of today's ink-jet recording system is attained only when all of the recording apparatus, ink, and exclusive use sheet are present.

However, for the ink-jet system which requires exclusive use sheets, the kinds of the recording medium are limited and the cost increase of the recording medium becomes a problem. Accordingly, many trials have been made to record onto the recording medium different from the exclusive use sheet using the ink-jet method. They are, for example, a phase change ink-jet system using a solid wax ink at a room temperature, a solvent type ink-jet system using a quick dry type organic solvent as a main component, or a UV ink-jet system in which a cross-linkage is formed by an ultra violet (UV) ray after recording.

Among the above-mentioned trials, the UV ink-jet system has a lower degree of smell than the solvent type ink-jet system. The UV ink-jet system has been paid attention in recent years by considering its rapid drying property and a capability to record on a non ink-absorptive medium. Listed examples are shown, in Japanese Patent Publication Open to Public Inspection (hereafter is called, JP-A) No. 5-54667, JP-A No. 6-200204, and Japanese Translated PCT Patent Publication No. 2000-504778, the ultraviolet ray curing type ink-jet ink is disclosed.

However, even when these inks are used, it is difficult to form the highly minute image onto various recording materials because a diameter of a dot reached on the recording material is largely changed due to the kind of the recording material or the working environment.

For example, as the ultraviolet ray curing type ink, there is disclosed a cation polymerization type ultraviolet ray curing type ink (e.g. Patent documents 1-3). The cation polymerization type ultraviolet ray curing type ink is not subjected to the oxygen inhibition action. However, there is a problem in which it is easily subjected to the influence of water, and the dark reaction is easily advanced, resulting a problem of low shelf keeping stability.

### SUMMARY

The present invention is attained to resolve the above-described problems. An object of the present invention is to provide an active ray curable ink composition capable of stably producing under various recording conditions a high-definition image of high quality with decreased bleeding and small wrinkle after being cured. An object of the present invention is also to provide an image forming method and an ink-jet recording apparatus using the same ink composition.

An aspect of the present invention includes an actinic ray curable ink composition, containing:
(a) a photoinitiator; and
(b) a photopolymerizable compound,
wherein the photoinitiator is an onium compound exhibiting a predetermined hydrophobicity value (log P_{(O/W)}), P_{(O/W)} being a partition coefficient of the onium compound between 1-octanol and water.

### BRIEF DESCRIPTION OF DRAWINGS

FIG. 1 is a front view of the main section of the ink-jet recording apparatus illustrating one embodiment of the present invention.

FIG. 2 is a top view of the main section of the ink-jet recording apparatus illustrating another embodiment of the present invention.

### DESCRIPTION OF THE PREFERRED EMBODIMENTS

The above-described objects of the present invention are attained by the following structures.

(1) An actinic ray curable ink composition, containing:
(a) a photoinitiator; and
(b) a photopolymerizable compound,
wherein the photoinitiator is an onium compound exhibiting a hydrophobicity value (log P_{(O/W)}) of less than 1.0, P_{(O/W)} being a partition coefficient of the onium compound between 1-octanol and water.

(2) The actinic ray curable ink composition of the above-described item 1,
wherein the onium compound is a sulfonium salt.

(3) The actinic ray curable ink composition of any one of the above-described items 1 and 2, further containing a basic compound.

(4) The actinic ray curable ink composition of any one of the above-described items 1 to 3,
wherein the onium compound exhibits log P_{(O/w)} of less than 0.2.

(5) The actinic ray curable ink composition of any one of the above-described items 1 to 4,
wherein the photopolymerizable compound is a compound having an oxetane group in the molecule.

(6) The actinic ray curable ink composition of any one of the above-described items 1 to 5,
wherein the following photopolymerizable compounds are contained:
(i) a compound having an oxetane group in the molecule;
(ii) a compound having an oxirane group in the molecule; and
(iii) a vinyl ether compound,
an amount of (i), (ii) and (iii) each being respectively, 30 to 95 weight %, 5 to 70 weight %, and 0 to 40 weight % based on the total weight of the photopolymerizable compounds.

(7) The actinic ray curable ink composition of any one of the above-described items 1 to 6,
wherein a viscosity of the ink composition at 25° C. is from 7 to 50 mP·s.

(8) A method of forming an image containing the steps of:
jetting droplets of the actinic ray curable ink composition of any one of the above-described items 1 to 7 from a plurality of nozzles of an ink-jet recording head onto a recording material to form an image; and
irradiating the formed image with actinic rays to cure the image,
wherein the irradiating step is carried out between 0.001 and 2.0 seconds after the jetted droplet of the ink composition reaches on the recording material.

(9) A method of forming an image containing the steps of:
jetting droplets of the actinic ray curable ink composition of any one of the above-described items 1 to 7 from a plurality of nozzles of an ink-jet recording head onto a recording material to form an image; and
irradiating the formed image with actinic rays to cure the image,
wherein the droplets of the actinic ray curable ink composition jetted from each nozzle of the ink-jet recording head have a volume of 2 to 20 pl.

(10) A method of forming an image containing the steps of:
jetting droplets of the actinic ray curable ink composition of any one of the above-described items 1 to 7 from a plurality of nozzles of an ink-jet recording head onto a recording material to form an image; and
irradiating the formed image with actinic rays to cure the image,
wherein the ink-jet head is a line-head.

(11) An ink-jet recording apparatus for carrying out the image forming method of any one of the above-described items 8 to 10,
wherein the actinic ray curable ink composition and the ink-jet recording head are heated at 35 to 100° C. prior to jetting the actinic ray curable composition from a plurality of nozzles of the ink-jet recording head.

According to the present invention, it is possible to provide an active ray curable ink composition capable of stably producing under various recording conditions a high-definition image of high quality with decreased bleeding and small wrinkle after being cured. It is also possible to provide an image forming method and an ink-jet recording apparatus using the same ink composition.

The preferred embodiments of the present invention will be further described below.

The present invention was achieved to overcome the above-described problems. It was discovered that in an actinic radiation curable ink composition incorporating a photoinitiator as well as a photopolymerizable compound, an image formed employing an actinic curable ink composition (hereinafter occasionally referred to simply as an ink), in which the aforesaid initiators were onium salts having a log P_{(O/W)}, (P_{(O/W)} represents a partition coefficient between 1-octanol and water) of less than 1.0, resulted in significant minimization of wrinkling formation during curing, and in addition, ejection stability as well as curability was improved. It was possible to achieve excellent image formation, irrespective of the curing ambience (temperature and humidity).

Heretofore, cationically polymerizable ink compositions have been employed in which sulfonium salts such as UV16974 and UV16992 (both being triarylsulfonium salts, produced by Dow Chemical Co.) are employed mainly as a photoinitiator. However, the above ink compositions resulted in problems in which wrinkling tended to form due to curing and ejection was unstable. As a result, it was difficult to form highly detailed images by ink-jet recording employing the above ink compositions. Further, known are ink compositions which employ IRGACURE 250 (being a diaryliodonuium salt, produced by Ciba Specialty Chemicals Co.) or CI5102 (being a diaryliodonium salt, produced by Nippon Soda Co., Ltd.). However, even though these are employed, none of examples has been found in which ink-jet ink compositions enable stable ejection.

The known sulfonium salts or iodonium salts have a defect in storage stability. The defect tends to yield insufficient curing of the ink and poor-ejection stability of the ink.

In order to overcome the above problems, onium salts having a log P_{(O/W)} of less than 1.0 of the present invention were employed. As a result, it was possible to form an ink-jet image which resulted in no wrinkling due to curing, as well as in excellent ejection stability. Particularly, by simultaneously employing compounds having an oxetane ring, during ink-jet recording, ejection stability, which is considered to be an important characteristic was markedly improved. Further, it was possible to easily control the dot diameter of the ink after deposition onto the recording material and it was possible to form high quality images under desired reproduction, independent of curing ambience. Further, it is preferable that basic compounds are employed together with the above ink compositions since wrinkling during curing is further minimized and ejection stability is further enhanced.

The present invention will now be detailed.

First, onium salts (photoinitiators) of the present invention having a log P_{(O/W)} of less than 1.0 will be described.

P_{(O/W)}, as described in the present invention, refers to the partition coefficient between 1-octanol and water and is as defined for the value which is treated as information to judge accumulativeness in the bodies of fish and shellfish, in the course of registration of new compounds, to conform in the Law Concerning Examination and Regulation of Manufacture etc. of Chemical Substances (a Japanese law), and is represented by the formula below;
P_{(O/W)}=C_{O}/C_{W}
wherein C_{O} represents the concentration (in mg/L) of a compound in the 1-octanol layer, while C_{W} represents the concentration (in mg/L) of the above compound in the water layer.

Heretofore, when the log P_{(O/W)} value of a compound is less than 3.0, it has been judged that the above compound exhibits low accumulativeness in the bodies of fish and shellfish, whereby concentrated tests are unnecessary. In the present invention, one of the desirable features is that onium salts of the above log P_{(O/W)} value of less than 1.0 are employed as a photoinitiator, while the log P_{(O/W)} value is more preferably less than 0.2. When log P_{(O/W)} is equal to or more than 1.0, wrinkling during curing depends on the types of photopolymerizable compounds as well as using ambience, and ejection stability is degraded. In addition, in order to increase ejection stability, it is preferable that sulfonium salts are employed.

The above described onium compounds are easily synthesized using commonly known methods. They are synthesized, for example, in'the same manner as the method to prepare a photo acid generator described in The Chemical Society of Japan, Vol. 71, No. 11 (1998) or in “Organic Materials for Imaging.” edited by The Japanese Research Association for Organic Electronics Materials (1993), Bun-Shin Publishing.

Basic compounds may also be added to the actinic ray curable composition of the present invention.

Addition of a basic compound may results in excellent ejection stability and prevention of wrinkles due to shrinkage even under a low moisture environment. As the basic compounds, the various known basic compounds may be used. Typical examples thereof include basic alkali metal compounds, basic alkali earth metal compounds, and basic organic compounds, such as an amine.

As the basic alkali metal compounds, listed are alkali metal hydroxides (such as lithium hydroxide, sodium hydroxide and potassium hydroxide), alkali metal carbonates (such as lithium carbonate, sodium carbonate and potassium carbonate), and alkali metal alcolates (such as sodium methoxide, sodium ethoxide, potassium methoxide and potassium ethoxide).

As the basic alkaline earth metal compounds, listed are alkaline earth metal hydroxides (such as magnesium hydroxide and calcium hydroxide), alkaline earth metal carbonates (such as magnesium carbonate and calcium carbonate), and alkaline earth metal alcolates (such as magnesium methoxide).

As the basic organic compounds, listed examples are amines and nitrogen containing heterocyclic compounds such as quinoline and quinolizine. Of these, amines are preferable from the viewpoint of compatibility with a photopolymerizable monomer. Examples are, octylamine, naphthylamine, xylenediamine, dibenzylamine, diphenylamine, dibutylamine, trioctylamine, tetramethylethylenediamine, tetramethyl-1,6-hexamethylenediamine, hexamethylenetetramine, and triethanolamine.

The concentration of the basic compound is 10 to 1,000 ppm by weight, and preferably 20 to 500 ppm by weight, based on the total weight of the photopolymerizable monomer. The basic compound may be used alone or in combination with a plurality thereof.

The ink of the present invention preferably contains a compound having an oxetane ring in the molecule as an actinic ray curable compound.

Next, an oxetane compound used for the ink of the present invention will be described. The oxetane compound is a compound having an oxetane ring, and for example, well known all oxetane compounds as disclosed in JP-A No. 2001-220526, and JP-A No. 2001-310937, can be used.

The ink of the present invention preferably contains an epoxy compound having an oxirane group in the molecule to improve hardening property and ejection stability.

Listed examples of an epoxy compound are the following aromatic epoxides, alicyclic epoxides and aliphatic epoxides.

Preferred examples of an aromatic epoxide are, polyhydric phenol having at least one aromatic nucleus or di or poly glycidyl ether which is produced by the reaction of its alkylene oxide additive body and epichloro-hydrin, and for example, bisphenol A or di or poly glycidyl ether of its alkylene oxide additive body, and novolak type epoxy resin are listed. Herein, as the alkylene oxide, ethylene oxide and propylene oxide are listed.

As an alicyclic epoxide, compounds including cyclohexene oxide or cyclopentene oxide obtained when compounds having at least one cyclo alkane ring such as cyclo hexene or cyclo pentene ring are epoxided by an adequate oxidation agent such as hydrogen peroxide or peroxy acid are preferable.

As a preferable aliphatic epoxide, there are listed as follows: aliphatic polyhydric alcohol or di or poly glycidyl ether of its alkylene oxide additive body, and as its representative example, di-glycidyl ether of ethylene glycol, di-glycidyl ether of propylene glycol, or di-glycidyl ether of alkylene glycol such as di-glycidyl ether of 1, 6 hexane diol, poly-glycidyl ether of polyhydric alcohol such as di or tri-glycidyl ether of glycerin or its alkylene oxide additive body, di-glycidyl ether of poly-alkylene glycol such as di-glycidyl ether of polyethylene glycol or its alkylene oxide additive body, di-glycidyl ether of poly-alkylene glycol such as di-glycidyl ether of polypropylene glycol or its alkylene oxide additive body. Herein, as an alkylene oxide, ethylene oxide and propylene oxide are listed.

Of these epoxides, upon considering rapid curing properties, preferred are aromatic epoxides as well as alicyclic epoxides, and particularly preferred are the alicyclic ones. In the present invention, the above epoxides may be employed singly or in suitable combinations of at least two types.

Further, in the present invention, in view of safety such as AMES test as well as sensitizing property, it is preferable that as epoxy compounds having an oxirane group, either an epoxidized fatty acid ester or an epoxidized fatty acid glyceride is incorporated.

Epoxidized fatty acid esters as well as epoxidized fatty acid glycerides are employed without any particular limitation as long as epoxy groups are introduced into the fatty acids or fatty acid glycerides. Employed as epoxidized fatty acid esters are: epoxidized oleic acid esters, methyl epoxystearate, butyl epoxystearate, and octyl epoxystearate. Employed as epoxidized fatty acid glycerides which are prepared by epoxidizing soybean oil, linseed oil, or castor oil are epoxidized soybean oil, epoxidized linseed oil, and epoxidized castor oil. Listed as epoxidized plant oil available on the market are, for example, Sansosizer E-4030, produced by Shin-Nippon Rika Co., Ltd. as well as Vf7170, Vf7190, Vf5075, Vf4050, Vf7010, Vf9010, Vf9040, and Vf7040, produced by ATOFINA Chemiclal Co.

Further, in the present invention, in view of safety such AMES test or sensitizing property, particularly preferred as epoxy compounds having an oxirane group is at least one of either epoxidized fatty acid esters or epoxidized fatty acid glycerides.

Epoxidized fatty acid esters as well as epoxidized fatty acid glycerides are employed without any particular limitation as long as epoxy groups are introduced into fatty acid esters and fatty acid glycerides. Employed as epoxidized fatty acid esters are methyl epoxystearate, butyl epoxystearate, and octyl epoxystearate which are prepared by epoxidizing oleic acid esters. Further, epoxidized fatty acid glycerides are also prepared by epoxidizing soybean oil, linseed oil, and castor oil, while epoxidized soybean oil, epoxidized linseed idol, and epoxidized castor oil are also employed.

Further, in the present invention, any vinyl ether compounds known in the art may be incorporated.

Examples of such vinyl ether compounds include di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, trimetnylolpropane trivinyl ether, as well as monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-O-propylene carbonate, dodecyl vinyl ether, diethylene glycol monovinyl ether, or octadecyl vinyl ether.

Of these vinyl ether compounds, in order to achieve high curability, high adhesion, and high surface hardness, preferred are di- or trivinyl ether compounds, and divinyl ether compounds are particularly preferred. In the present invention, the above vinyl ether compounds may be employed individually or in appropriate combinations of at least two types.

Further, the ink of the present invention preferably contains 30-95 percent by weight of at least one of the oxetane compounds, 5-70 percent by weight of at least one of the compounds having a oxirane group, and 0-40 percent by weight of at least one of the vinyl ether compounds.

The actinic ray curable ink composition of the present invention preferably contains a various kinds of colorants such as a dye or a pigment known in the art along with the above-described actinic ray curable compositions. The colorant is preferably a pigment.

The pigments preferably used in the present invention are listed below. However, the present invention is not limited thereby.

The pigments which can be preferably used, will be listed below.
C. I Pigment Yellow—1, 3, 12, 13, 14, 17, 81, 83, 87, 95, 109, 42.
C. I Pigment Orange—16, 36, 38
C. I Pigment Red—5, 22, 38, 48:1, 48:2, 48:4, 49:1, 53:1, 57:1, 63:1, 144, 146, 185, 101.
C. I Pigment Violet—19, 23
C. I Pigment Blue—15:1, 15:3, 15:4, 18, 60, 27, 29
C. I Pigment Green—7, 36
C. I pigment White—6, 18, 21
C. I pigment Black—7

Further, in the present invention, in order to increase the shielding property of the color in the transparent base material such as the plastic film, it is preferable to use a white ink. Particularly, in the soft package printing, or label printing, it is preferable to use a white ink. However, when a white ink is used, the jetting amount becomes large. In order to keep the jetting stability and to prevent generation of the curl and wrinkle, there is naturally a limitation as for the using amount.

For the dispersion of the pigment, for example, a ball mill, sand mill, attritor mill, roll mill, agitator, Henshel mixer, colloid mill, ultrasonic homogenizer, pearl mill, wet jet mill, or paint shaker can be used. Further, when the pigment is dispersed, a dispersing agent can also be added. As the dispersing agent, it is preferable that the polymeric dispersing agent is used, and as the polymeric dispersing agent, SOLSPERSE series by Avecia Co., are listed. Further, as the dispersion auxiliary, a synergist corresponding to each kind of pigment can also be used. In these dispersing agent and dispersion auxiliary, it is preferable that, to 100 mass part of the pigment, 1-50 mass part of the dispersing auxiliary is added. As dispersion medium, the dispersion is conducted by using the solvent or polymerization compound, however, it is preferable that the active ray curing type ink used in the present invention contains no solvent because, without solvent, it is reacted and cured just after the ink impacts. When the solvent remains on the cured image, a problem of the deterioration of the solvent resistance, and the problem of VOC derived from the remaining solvent is generated. Accordingly, it is preferable in the dispersion property that the dispersion medium is not the solvent, but the polymerization compounds, and in them, the monomer whose viscosity is lowest is selected.

In the dispersion of the pigment, it is preferable that the average particle diameter of the pigment particle is 0.08-0.5 μm, maximum particle diameter is 0.3-10 μm, and preferably, the selection of the pigment, dispersing agent and the dispersion medium, and the dispersing condition, and filtering condition are set so that maximum particle diameter is 0.3-3 μm. By this particle diameter control, the choking of the head nozzle can be suppressed, and conservation stability of the ink, ink transparency and curing sensitivity can be maintained.

In the ink according to the present invention, various additive agents can be used other than the above description. For example, the interface active agent, leveling additive agent, mat agent, polyester resin to adjust the film physical properties, polyurethane resin, vinyl resin, acrylic resin, rubber resin, or wax can be added. Further, in order to improve the conservation stability, although all well known basic compounds can be used, as representative compounds, the basic alkali-metal compound, basic alkali earth metal compound, basic organic compound such as amine are listed. Further, the radical polymerization monomer and the initiator are combined, and it can also be made the hybrid type cured ink of the radical cation.

The ink of the present invention preferably has a viscosity of 7 to 50 mPa·s at 25° C. to improve ejection stability regardless of the hardening conditions of temperature and moistures and to obtain a good hardening property.

As the recording material which can be used in the present invention, other than an ordinary non-coat sheet and coat sheet, each kind of non-absorptive plastic used for so-called soft package and its film can be used, and as each kind of plastic film, for example, PET film, OPS film, OPP film, ONy film, PVC film, PE film, or TAC film can be listed. As the other plastic, polycarbonate, acrylic resin, ABS, polyacetal, PVA, or rubber can be used. Further, it can also be applied to metal or glass.

In these recording materials, particularly when the image is formed onto the PET film, OPS film, OPP film, ONy film, PVC film, which are shrinkable by the heat, the structure of the present invention is effective. In these base materials, not only the curl and deformation of the film are easily generated by the heat generation at the time of curing shrinkage and curing reaction of the ink, but the ink film also hardly follows the shrinkage of the base material.

The surface energy of each kind of plastic film is largely different, and conventionally, it is a problem that the dot diameter after the ink impact is changed depending on the recording material. In the structure of the present invention, the good high minute image can be formed on the recording material of the wide range in which the surface energy is 3.5-6.0×10⁻² Nm⁻¹, including OPP film, OPS film, whose surface energy is low, and PET whose surface energy is comparatively large.

In the present invention, it is advantageous to use a long sized (web) recording material by considering the cost of the recording material such as the package cost and the production cost; the production efficiency of the print; and applicability to a various kinds of print size.

The image forming method of the present invention will be described below.

In the image forming method of the present invention, it is preferable to produce an image on an image forming material with an ink-jet recording method, then irradiate the formed image with an actinic ray such as a UV ray to cure the image.

(Actinic Ray Irradiation Condition After Ink has been Ejected onto Recording Material)

In the image recording method of the present invention, it is preferable that actinic rays are irradiated within 0.001 to 2.0 seconds after ink has been deposited on the recording material, and it is more preferable that actinic rays are irradiated within 0.001 to 1.0 second after ink has been deposited on recording material. Irradiation of actinic rays as early as possible after ejecting the ink is specifically important in order to form high resolution images.

An actinic ray irradiation method has been basically disclosed in JP-A No. 60-132767, in which light sources are provided at the both sides of a head unit where a head and a light are scanned in a shuttle system. Irradiation is performed in a certain time interval after ink has been deposited on the recording material. Further, curing is completed by another light source which is not driven. In U.S. Pat. No. 6,145,979, the following light irradiation methods have been disclosed: (i) a method utilizing optical fibers; and (ii) a method in which collimated light is reflected by a mirror provided on the side surface of a head unit, and UV light (ultraviolet light) is irradiated on the recording portion. In the image forming method of the present invention, any of these irradiation methods may be utilized.

Further, the following method is also preferable: irradiation of actinic rays is divided into two steps, (i) first actinic ray irradiation is 0.001 to 2.0 seconds after ink has been deposited on recording material by the above-described method; and (ii) second actinic ray irradiation is carried out after all the printing has been completed. Shrinkage of recording materials, occurring while the ink is being cured can be reduced by dividing actinic ray irradiation into those two steps.

In the past, in a UV curable ink-jet method, usually a high power light source exceeding 1 kW·hr has been used in order to minimize spreading of dots and bleeding-out after the ink deposition on recording material. However, specifically in printing-on shrink labels, the shrinkage of the recording material due to the UV irradiation has been too much for practical use.

In the present invention, even when a light source with a power less than 1 kW·hr is used, images with high resolution can be formed, and shrinkage of a recording material is in the permissible range. Examples of the light sources having a power of less than 1 kW-hr include a fluorescent lamp, a cold cathode tube and a LED, however, the present invention is not limited thereto.

(Thickness of Ink Layer Formed After Ink is Ejected onto Recording Material)

In the present invention, the thickness of an ink layer, after ink has been ejected onto recording material and cured by actinic ray irradiation, is preferably from 2 to 25 μm. In actinic ray curable ink-jet recording in the field of screen printing, the thickness of the ink is at present over 25 μm. Ink ejection of an excessive layer thickness is not preferred in the field of flexible package printing where a thin plastic film is used as a recording material, because problems are caused in that stiffness and texture may change by such printing, in addition to the problems of the aforementioned curl and wrinkles of recording material.

Herein, the thickness of an ink layer refers to the maximum thickness of the ink layer deposited on the recording material. This is common to a single color ink layer, and an overlapped layer of two different color (secondary color) inks, three different color inks or four different color inks (including white ink as a base ink), which are formed on recording material according to an ink jet recording process.

(Heating and Ejecting Conditions of Ink)

In the image recording method of the present invention, it is preferable that actinic radiation curable ink is exposed to actinic radiation while heated.

As one of the methods, to obtain high ejection stability, it is preferable that an ink-jet recording head as well as ink is maintained at 35-100° C., while the resulting ink is ejected onto recording materials.

Further, as method of the present invention, to obtain high ejection stability, it is preferable that ink is ejected from the ink-jet recording heads while each of the ink-jet recording heads and the ink is maintained at 35-80° C., and after deposition of the ink onto a recording materials, actinic radiation is irradiated under such a state that the temperature is maintained at 35-80° C. In the present invention, methods to heat the ink-jet recording heads and the ink and to maintain their temperature at the specified value are not particularly limited. For example, there is a method in which an ink feeding system such as an ink tank constituting a head carriage, a feeding pipe, or a pre-chamber ink tank just prior to the heads, piping with filters, and piezo heads are insulated from heat and heated to the predetermined temperature employing a panel heater, a ribbon heater, or temperature regulated water.

Further, listed as methods to maintain the temperature at the predetermined value after deposition of the ink onto recording materials, may, for example, be a method in which a panel heater is mounted on the holding section of recording materials and a method in which a recording material conveying section is enclosed and heated employing warm air flow.

An actinic radiation curable ink exhibits a broad viscosity range depending largely on the change of temperature, and viscosity variation directly affects the size and ejection rate of ink droplets, resulting in degradation of image quality. Consequently, it is necessary to maintain a constant temperature. The controlled range of ink temperature is preferably the predetermined temperature ±5° C., is more preferably the predetermined temperature ±2° C., but is further more preferably the predetermined temperature ±1° C.

The droplet volume of the ink ejected from each ink nozzle is preferably 2 to 20 pl. The droplet volume of the ink is preferably in the range described above to form high resolution images, however, it is not an easy matter to stably eject droplets in this volume range. In the present invention, even when a small droplet volume such as 2 to 20 pl is ejected, ejection stability is maintained, resulting in high resolution images.

The ink-jet recording apparatus (hereafter, it is also referred to as a recording apparatus) of the present invention will be described.

The recording apparatus of the present invention will be described by reference with figures. The recording apparatus in the figures are exemplary embodiments and the recording apparatus of the present invention is not limited by them.

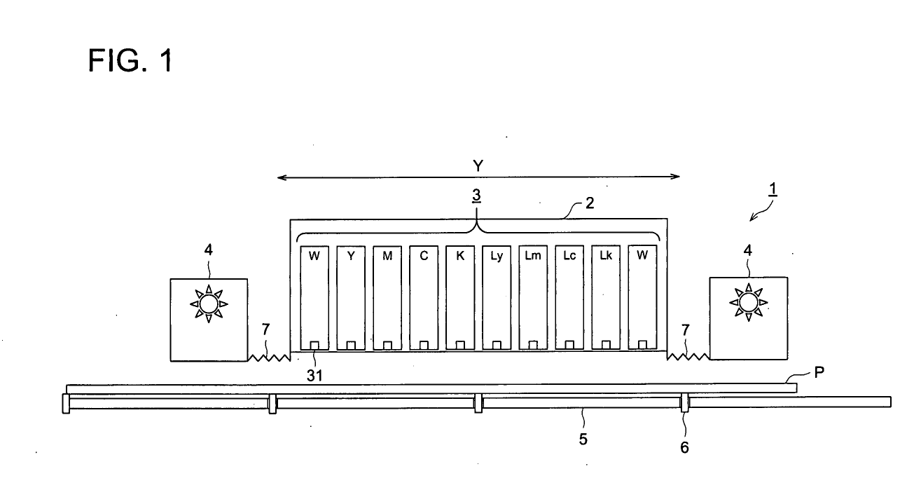

FIG. 1 shows a front view of the main section of the ink-jet recording apparatus of the present invention. Recording apparatus 1 is equipped with head carriage 2, recording head 3, irradiation member 4 and platen 5. In recording apparatus 1, platen 5 is provided under recording sheet P. Platen 5 functions also as a UV ray absorbing means, and absorbs excess UV rays having passed through recording sheet P. As a result, high resolution images are reproduced quite stably.

Recording sheet P is guided by guide member 6 to be moved to the back side from the front side in FIG. 1 by means of a transport member (not illustrated). Scanning of recording heads 3 mounted in the head carriage 2 is achieved by reciprocating head carriage 2 in the Y direction in FIG. 1 by means of a head scanning member (not illustrated).

Head carriage 2 is provided over recording sheet P, and stores a plurality of recording heads 3 described below with the ink ejection orifices oriented downward. Head carriage 2 is provided in the main body of recording apparatus 1 so as to reciprocate in the Y direction, as shown in FIG. 1, driven by a head scanning member.

Herein, FIG. 1 illustrates that head carriage 2 carries ten recording heads 3, however, in the present invention, the number of recording heads 3 mounted in head carriage 2 is determined considering the number of inks.

Recording heads 3 eject an actinic ray curable ink (for example, a UV curable ink) supplied by an ink supplying member (not illustrated) from the ink ejection orifices onto recording sheet P by action of plural ejecting members (not illustrated) equipped in the recording apparatus. The UV curable ink ejected from recording heads 3 is a composition containing a colorant, a polymerizable polymer and an initiator, and has a property to be cured via a cross-linking and polymerizing reaction initiated by irradiation of UV rays where the initiator works as a catalyst.

Recording heads 3 ejects ink as ink droplets onto a pre-determined region (the region designated to receive the ink) of recording sheet P while the head is scanned from one edge to the other of the recording sheet in the Y direction in FIG. 1 by means of the head scanning member, whereby the ink is deposited on the designated region of the recording sheet.

The above scan is made several times as required to eject ink onto the region designated to receive the ink. After that, recording sheet P is transported from the front side to the back side of the page in FIG. 1 by a transport member and the scan of the recording heads 3 is again made, driven by the head scan member, whereby ink is ejected from the recording heads onto an adjacent region designated to receive the ink.

The above operation is repeatedly carried out, whereby the ink is ejected from recording heads 3 employing the head scan member and the transport member to form an image made of aggregates of ink droplets on recording sheet P.

Irradiation member 4 is equipped with a UV lamp which emits ultraviolet rays of a specific wavelength range at a stable exposure energy and a filter which transmits ultraviolet rays of a specific wavelength. Herein, examples of the UV lamp include a mercury lamp, a metal halide lamp, an excimer laser, a UV laser, a cold cathode tube, a hot cathode tube, a black light, and an LED (light emitting diode). Of these, a metal halide lamp giving a band-shaped light, a cold cathode tube, a mercury lamp and a black light are preferable. Specifically a cold cathode tube and a black light, which emit 254 nm ultraviolet rays are preferable, which can prevent bleeding-out, efficiently control a dot diameter, and reduce wrinkles on curing. Utilizing a black light as a radiation source of irradiation member 4 reduces the manufacturing cost for ink curing.

Irradiation member 4 has the possible largest size which can be installed in recording apparatus 1 (an ink jet printer) or the size which is larger than the region designated to receive the ink by one scan of recording heads 3, driven by the head scanning member.

Irradiation member 4 is equipped nearly in parallel with recording sheet P by fixing at the both sides of head carriage 2.

In order to adjust luminance at the ink ejection outlets, the entire recording heads 3 is light-shielded, however, in addition, it is preferable to make distance h2 between the ink ejection outlet 31 of recording heads 3 and recording sheet P greater than distance h1 between irradiation means 4 and recording sheet P (h1<h2) or to increase distance d between recording heads 3 and irradiation means 4 long (to make d large). Further, it is more preferable to provide bellows structure 7 between recording heads 3 and irradiation member 4.

Herein, the wavelength of ultraviolet rays, which are irradiated through irradiation member 4, is suitably changed by exchange of a UV lamp or a filter, which is mounted in irradiation member 4.

The ink-jet ink of the present invention has excellent ejection stability, and is specifically suitable for use in a line head type ink-jet recording apparatus.

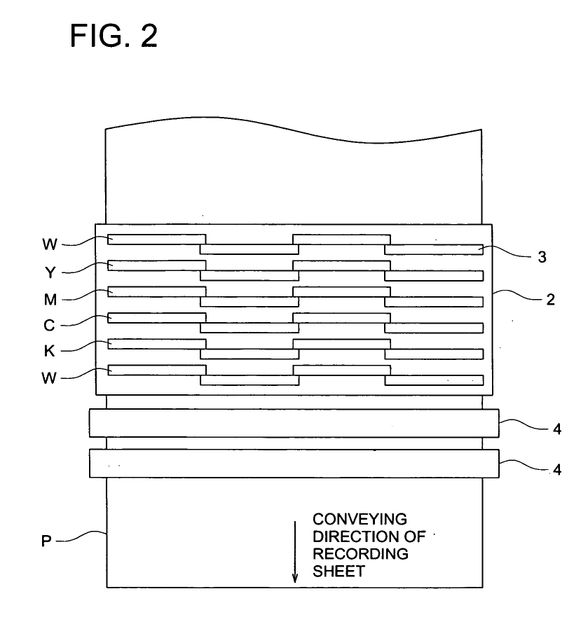

FIG. 2 shows a top view of the main section of the ink-jet recording apparatus explaining another embodiment of the present invention.

The ink-jet recording apparatus illustrated in FIG. 2 is called as a line head type ink-jet recording apparatus. Recording heads 3 are provided in head carriage 2, which covers the entire width of recording sheet P. The recording heads 3 each stores a different color ink.

Irradiation means 4 is provided just downstream of head carriage 2 to cover the entire width of recording sheet P and the entire printing surface. The same ultraviolet lamp as shown in FIG. 1 may be used in the irradiation means 4 in FIG. 2.

In the line head type recording apparatus, head carriage 2 and irradiation means 4 are fixed, and only recording sheet P is transported in the direction as shown in FIG. 2. Ink is ejected onto the recording sheet, which is subsequently transported and then exposed via the irradiation means to form a cured image on the recording sheet.

### EXAMPLES

The present invention will now be explained using examples, however, the present invention is not limited thereto. <<Preparation of an Ink Composition Set>>

Ink Composition Sets 1-6 composed as described in Tables 1-6 were prepared based on the methods below.

While stirring, charged into a stainless steel beaker heated on a hot plate at 65° C. were 3 parts by weight of a dispersing agent (PB822, produced by Ajinomoto-Fine-Techno Co., Inc.) and each of the photopolymerizable compounds described in Tables 1-6, were mixed and dissolved over one hour. Subsequently, after adding each of the colorants described in Tables 1-6 to the above solution, the resulting mixture was placed in a plastic bottle together with 200 g of 200 mm diameter zirconia beads and dispersed for two hours employing a paint shaker. Subsequently, the zirconia beads were removed and various types of additives such as photolytically acid generating agents, sensitizers, compatibilizesr, basic compounds, or surface active agents were added in the combinations as described in Tables 1-6. Each of the resulting mixtures was filtered employing a 0.8 μm membrane filter to minimize printer head clogging, whereby Ink Composition Sets 1-6 were prepared.

The viscosity of each color ink of each of the ink composition sets prepared as above is as follows. The viscosity is represented by the viscosity range between the maximum and the minimum of each color ink at 25° C.
Ink Composition Set 1: 19-22 mPa·s
Ink Composition Set 2: 30-32 mPa·s
Ink Composition Set 1: 25-27 mPa·s
Ink Composition Set 1: 28-32 mPa·s
Ink Composition Set 1: 28-30 mPa·s

Ink Composition Set 1: 24-28 mPa·s

TABLE 1
Ink Composition (weight %)

| | | | Photopolymerizable Compound | | | | |
|---|---|---|---|---|---|---|---|
| | Colorant | | | *0 | | Photo- | Dispersing |
| Ink | | Added | *E1 | OXT- | OXT- | initiator | Agent |
| Type | Type | Amount | LD0 | 221 | 101 | UV16992 | PB822 |

Ink Composition Set 1 (Comparative Example)

| | | | | | | | |
|---|---|---|---|---|---|---|---|
| K | Colorant 1 | 3.0 | 39.0 | 30.0 | 20.0 | 5.0 | 3.0 |
| C | Colorant 2 | 2.5 | 39.5 | 30.0 | 20.0 | 5.0 | 3.0 |
| M | Colorant 3 | 2.5 | 39.5 | 30.0 | 20.0 | 5.0 | 3.0 |
| Y | Colorant 4 | 3.0 | 39.0 | 30.0 | 20.0 | 5.0 | 3.0 |
| W | Colorant 5 | 5.0 | 37.0 | 30.0 | 20.0 | 5.0 | 3.0 |
| Lk | Colorant 1 | 0.8 | 43.3 | 30.0 | 20.0 | 3.0 | 3.0 |
| Lc | Colorant 2 | 0.6 | 43.4 | 30.0 | 20.0 | 3.0 | 3.0 |
| Lm | Colorant 3 | 0.6 | 43.4 | 30.0 | 20.0 | 3.0 | 3.0 |
| Ly | Colorant 4 | 0.8 | 43.3 | 30.0 | 20.0 | 3.0 | 3.0 |

TABLE 2
Ink Composition (weight %)

| | | | Photopolymerizable | | | | | | |
|---|---|---|---|---|---|---|---|---|---|
| | | | Compound | | | | | | |
| | | | *E1 | | | Surface | | Photo- | |
| | Colorant | | | Com- | *0 | Active | | initiator | Dispersing |
| Ink | | Added | | pound | OXT- | Agent | | Compound | Agent |
| Type | Type | Amount | S2021P | EP-2 | 221 | F178k | F1405 | S-1 | PB822 |

Ink Composition Set 2 (Present Invention)

| | | | | | | | | | |
|---|---|---|---|---|---|---|---|---|---|
| K | Colorant 1 | 3.0 | 13.0 | 30.0 | 40.0 | 7.0 | 0.02 | 4.0 | 3.0 |
| C | Colorant 2 | 2.5 | 13.5 | 30.0 | 40.0 | 7.0 | 0.02 | 4.0 | 3.0 |
| M | Colorant 3 | 2.5 | 13.5 | 30.0 | 40.0 | 7.0 | 0.02 | 4.0 | 3.0 |
| Y | Colorant 4 | 3.0 | 13.0 | 30.0 | 40.0 | 7.0 | 0.02 | 4.0 | 3.0 |
| W | Colorant 5 | 5.0 | 11.0 | 30.0 | 40.0 | 7.0 | 0.02 | 4.0 | 3.0 |
| Lk | Colorant 1 | 0.8 | 15.2 | 30.0 | 40.0 | 7.0 | 0.02 | 4.0 | 3.0 |
| Lc | Colorant 2 | 0.6 | 15.4 | 30.0 | 40.0 | 7.0 | 0.02 | 4.0 | 3.0 |
| Lm | Colorant 3 | 0.6 | 15.4 | 30.0 | 40.0 | 7.0 | 0.02 | 4.0 | 3.0 |
| Ly | Colorant 4 | 0.8 | 15.2 | 30.0 | 40.0 | 7.0 | 0.02 | 4.0 | 3.0 |

TABLE 3
Ink Composition (weight %)

| | | | Photopolymerizable | | | | | | | |
|---|---|---|---|---|---|---|---|---|---|---|
| | | | Compound | | | | | | | |
| | Colorant | | | *E1 | *0 | | Basic | Compati- | Photo initiator | Dispersing |
| Ink | | Added | *E2 | Compound | OXT- | OXT- | Compound | bilizer | Compound | Agent |
| Type | Type | Amount | Vf9040 | EP-1 | 221 | 212 | *1 | BDB | S-2 | PB822 |

Ink Composition Set 3 (Present Invention)

| | | | | | | | | | | |
|---|---|---|---|---|---|---|---|---|---|---|
| K | Colorant 1 | 3.0 | 8.0 | 24.0 | 40.0 | 10.0 | 0.05 | 7.0 | 5.0 | 3.0 |
| C | Colorant 2 | 2.5 | 8.0 | 24.5 | 40.0 | 10.0 | 0.05 | 7.0 | 5.0 | 3.0 |
| M | Colorant 3 | 2.5 | 8.0 | 24.5 | 40.0 | 10.0 | 0.05 | 7.0 | 5.0 | 3.0 |
| Y | Colorant 4 | 3.0 | 8.0 | 24.0 | 40.0 | 10.0 | 0.05 | 7.0 | 5.0 | 3.0 |
| W | Colorant 5 | 5.0 | 8.0 | 22.0 | 40.0 | 10.0 | 0.05 | 7.0 | 5.0 | 3.0 |
| Lk | Colorant 1 | 0.8 | 8.0 | 26.2 | 40.0 | 10.0 | 0.05 | 7.0 | 5.0 | 3.0 |
| Lc | Colorant 2 | 0.6 | 8.0 | 26.3 | 40.0 | 10.0 | 0.05 | 7.0 | 5.0 | 3.0 |
| Lm | Colorant 3 | 0.6 | 8.0 | 26.3 | 40.0 | 10.0 | 0.05 | 7.0 | 5.0 | 3.0 |
| Ly | Colorant 4 | 0.8 | 8.0 | 26.2 | 40.0 | 10.0 | 0.05 | 7.0 | 5.0 | 3.0 |

TABLE 4
Ink Composition (weight %)

| | | | Photopolymerizable | | | | | |
|---|---|---|---|---|---|---|---|---|
| | | | Compound | | | | | |
| | Colorant | | *E1 | *O | | Basic | Photo- | Dispersing |
| Ink | | Added | UVR- | OXT- | OXT- | Compound | initiator | Agent |
| Type | Type | Amount | 6110 | 221 | 212 | *2 | UV16974 | PB822 |

Ink Composition Set 4 (Comparative Example)

| | | | | | | | | |
|---|---|---|---|---|---|---|---|---|
| K | Colorant 1 | 3.0 | 34.4 | 36.0 | 20.0 | 0.10 | 3.5 | 3.0 |
| C | Colorant 2 | 2.5 | 34.9 | 36.0 | 20.0 | 0.10 | 3.5 | 3.0 |
| M | Colorant 3 | 2.5 | 34.9 | 36.0 | 20.0 | 0.10 | 3.5 | 3.0 |
| Y | Colorant 4 | 3.0 | 34.4 | 36.0 | 20.0 | 0.10 | 3.5 | 3.0 |
| W | Colorant 5 | 5.0 | 32.4 | 36.0 | 20.0 | 0.10 | 3.5 | 3.0 |

TABLE 5
Ink Composition (weight %)

| | | | Photopolymerizable | | | | | | | |
|---|---|---|---|---|---|---|---|---|---|---|
| | | | Compound | | | | Surface | | Photo- | |
| | Colorant | | | | *E3 | Basic | Active | Compati- | initiator | |
| Ink | | Added | *E1 | | AOE- | Compound | Agent | bilizer | Compound | Dispersing |
| Type | Type | Amount | S2021P | S3000 | X68 | *3 | F178k | 145P | S-3 | Agent PB822 |

Ink Composition Set 5 (Present Invention)

| | | | | | | | | | | |
|---|---|---|---|---|---|---|---|---|---|---|
| K | Colorant 1 | 3.0 | 41.9 | 30.0 | 15.0 | 0.05 | 0.02 | 3.0 | 4.0 | 3.0 |
| C | Colorant 2 | 2.5 | 42.4 | 30.0 | 15.0 | 0.05 | 0.02 | 3.0 | 4.0 | 3.0 |
| M | Colorant 3 | 2.5 | 42.4 | 30.0 | 15.0 | 0.05 | 0.02 | 3.0 | 4.0 | 3.0 |
| Y | Colorant 4 | 3.0 | 41.9 | 30.0 | 15.0 | 0.05 | 0.02 | 3.0 | 4.0 | 3.0 |
| W | Colorant 5 | 5.0 | 39.9 | 30.0 | 15.0 | 0.05 | 0.02 | 3.0 | 4.0 | 3.0 |

TABLE 6
Ink Composition (weight %)

| | | | Photopolymerizable Compound | | | | | | Surface | | Photo- | |
|---|---|---|---|---|---|---|---|---|---|---|---|---|
| | Colorant | | *O | | | *E1 | *E4 | Basic | Active | Compati- | initiator | Dispersing |
| Ink | | Added | OXT- | OXT- | OXT- | Compound | E- | Compound | Agent | bilizer | Compound | Agent |
| Type | Type | Amount | 221 | 101 | 212 | EP-1 | 4030 | *1 | KF-352 | MB | S-3 | PB822 |

Ink Composition Set 6 (Present Invention)

| | | | | | | | | | | | | |
|---|---|---|---|---|---|---|---|---|---|---|---|---|
| K | Colorant 1 | 3.0 | 35.0 | 5.0 | 5.0 | 30.0 | 6.9 | 0.10 | 0.05 | 5.0 | 7.0 | 3.0 |
| C | Colorant 2 | 2.5 | 35.0 | 5.0 | 5.0 | 30.0 | 9.4 | 0.10 | 0.05 | 5.0 | 5.0 | 3.0 |
| M | Colorant 3 | 2.5 | 35.0 | 5.0 | 5.0 | 30.0 | 9.4 | 0.10 | 0.05 | 5.0 | 5.0 | 3.0 |
| Y | Colorant 4 | 3.0 | 35.0 | 5.0 | 5.0 | 30.0 | 8.9 | 0.10 | 0.05 | 5.0 | 5.0 | 3.0 |
| W | Colorant 5 | 5.0 | 35.0 | 5.0 | 5.0 | 30.0 | 4.9 | 0.10 | 0.05 | 5.0 | 7.0 | 3.0 |

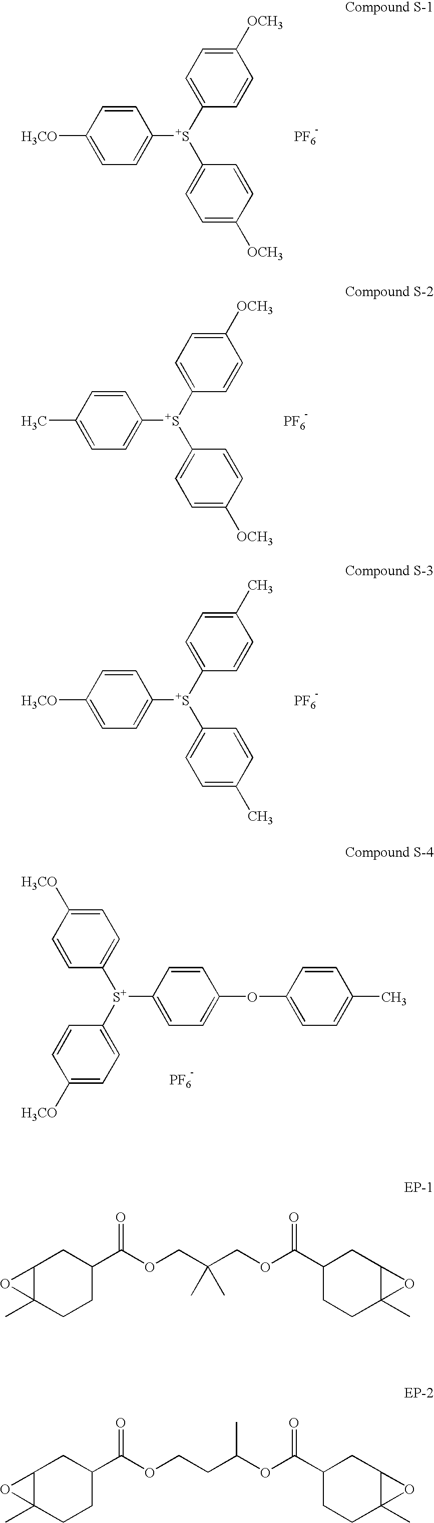

The abbreviation of each of the inks and the compounds listed in Tables 1-6 will now be detailed below.
K: dark black ink
C: dark cyan ink
M: dark magenta ink
Y: dark yellow ink
Lk: light black ink
Lc: light cyan ink
Lm: light magenta ink
Ly: light yellow ink
Colorant 1: C.I. Pigment Black 7
Colorant 2: C.I. Pigment Blue 15:3
Colorant 3: C.I. Pigment Red 57:1
Colorant 4: C.I. Pigment Yellow 13
Colorant 5: titanium oxide (anatase type, at an average particle diameter of 0.20 μm)
   (Photopolymerizable Compounds)
<*E1: alicyclic epoxy compound>
LDO: LDO (produced by ATOFINA Co.)
S2021P: CELOXIDE 2021P (produced by Dicel Chemical Industries, Ltd.)
S3000: CELOXIDE 3000 (produced by Dicel Chemical Industries, Ltd.)
UVR6110: UVR-6110 (produced by Dow Chemical Co.)
<*E2: epoxidized linseed oil>
Vf9040: VIKOFLEX 9040 (produced by ATOFINA Co.)
<*E3: epoxy compound>
AOE-X68: low molecular weight epoxy compound, AOE-X68 (produced by Dicel Chemical Industries, Ltd.)
<*E4: epoxidized fatty acid butyl>
E40340: SANSOSIZER E-4030 (produced by New Japan Chemical Co., Ltd.)
<*O: oxetane compounds>
OXT-101: produced by Toagosei Chemical Industry Co., Ltd.
OXT-212: produced by Toagosei Chemical Industry Co., Ltd.
OXT-221: produced by Toagosei Chemical Industry Co., Ltd.
   (Photoinitiators)
UV16974: produced by Dow Chemical Co., 50% propion carbonate liquid
UV16992: produced by Dow Chemical Co., 50% propion carbonate Liquid

Incidentally, log P_{(O/W)} of each of the photoinitiators listed in Tables 1-6 is as follows.
Compound S-1: log P_{(O/W)}=0.10
Compound S-2: log P_{(O/W)}=0.12
Compound S-3: log P_{(O/W)}=0.12
Compound S-4: log P_{(O/W)}=0.15
UV16974 log P_{(O/w)}=3.80
   (a mixture of two compounds each having log P_{(O/W)}=2.61 and log P_{(O/W)}=4.09, weight ratio of each being 80:20.)
UV16992: log P_{(O/W)}=3.80
   (a mixture of two compounds each having log P_{(O/W)}=2.61 and log P_{(O/W)}=4.09, weight ratio of each being 80:20.)
   (Basic Compounds)
*1: triisopropanolamine
*2: tributylamine
*3: N-ethyldiethanolamine
   (Surface Active Agents)
F178k: MEGAFAX F178k, perfluoroalkyl group containing acryloligomer (produced by Dainippon Ink and Chemicals, Inc.)
F1405: MEGAFAX F1405, a perfluoroalkyl group containing ethylene oxide addition product (produced by Dainippon Ink and Chemicals, Inc.)
KF-352: produced by Shin-Etsu Silicone Co.
   (Compatibilizers)
BDB: HISOLV BDB, glycol ether, produced by Toho Chemical Industry Co., Ltd.
145P: HARITAC 145P (rosin modified maleic acid resin, produced by Harima Kagaku Co.)
MB: HICHEMIC MB, anisole, produced by Toho Chemical Industry Co., Ltd.
   (Dispersing Agent)
PB822: produced by Ajinomoto-Fine-Techno Co., Inc.
   (Other)
*1: N-ethyldiethanolamine (a basic compound)
*2: tributylamine (a basic compound)
*3: propylene carbonate (a reagent, produced by Kanto Kagaku)
   <<Method for Forming Ink-Jet Images>>

Each of Ink Composition Sets 1-3, prepared as above, was loaded into an ink-jet recording apparatus, provided with piezo type ink-jet nozzles, which was constituted as shown in FIG. 1, and image recording described below was continuously performed on respective 600 mm wide by 500 m long recording materials each having the surface energy listed in Table 7. The ink feeding system containing an ink tank, a feeding pipe, a pre-chamber ink tank just prior to the head, piping with filters, and piezo heads, and the portion from the pre-chamber tank to the heads was insulated from heat, was heated to 50° C. The piezo head was driven so that 2-15 μl multi-size dots were ejected at a resolution of 720×720 dpi and each ink was continuously ejected. After deposition of the ink droplets, ultraviolet radiation was instantly (less than 0.5 second after deposition) irradiated employing each of the radiation sources listed in Table 7, which were arranged as lamp units on both sides of the carriage, hereby the ink was cured. The total ink layer thickness was determined after image recording, resulting in the range of 2.3-13 μm. Incidentally, dpi represents the number of dots per 2.54 cm.

Subsequently, by employing the ink-jet recording apparatus of the line head system described in FIG. 2, each of the images was formed in the same manner, while employing each of Ink Composition Sets 4-6. Further, a heating plate was provided on the platen section and the temperature of the heating plate was controlled so that the surface of each recording material reached 40° C. Sample Nos. 1-24 were thus prepared.

Further, Ink Composition Sets 4 and 6 each were subjected to storage condition of 70° C. for 4 days in a sealed bottle, then sample images Nos. 25-28 (using Ink Set 4) and sample images Nos. 29-32 (using Ink Set 6) were recorded with them using different recording materials as indicated in Table 7.

Employing the above two systems, printing was performed at three ambiences of 10° C. and 20 percent relative humidity, 23° C. and 50 percent relative humidity, as well as 27° C. and 80 percent relative humidity.

Incidentally, each of the irradiation light sources listed in Table 7 is detailed below.

Irradiation Light Source A: High Pressure Mercury Lamp

VZero085 (produced by INTEGRATION TECHNOLOGY Co.) Irradiation Light Source B: a hot cathode tube (a custom order product, produced by Nippo Co., power source of 200 W)

Further, with regard to illuminance of each of the irradiation light sources listed in Table 7, integrating illuminance at 254 nm was determined employing UVPF-A1, produced by Iwasaki Electric Co., Ltd. and tabulated.

Further, abbreviation of each of the recording materials listed in Table 7 is detailed below.
OPP (Yupo FS): oriented polypropylene (Yupo FS)
PET: polyethylene terephthalate

PVC: polyvinyl chloride

TABLE 7

| | | | | Irradiation Conditions | | | | | | |
|---|---|---|---|---|---|---|---|---|---|---|
| | | | | | | | | On Recording | | |
| | | Recording | | | | | | Material | | |
| | | Material | | | Irradiation | | Irradiation | Measured | | |
| | Ink | | Surface | Irradiation | Method (area) | | Sequence | Wavelength | Maximum | |
| Sample | Set | | Energy | Light | Irradiation | Light | (after | Region | Illuminance | |
| No. | No. | Type | mN/m | Source | Position | Source | deposition) | nm | mW/cm² | Remarks |
| 1 | 1 | *3 | 38 | A | *1 | *5 | *6 | 254 | 400 | Comp. |
| 2 | 1 | PET | 53 | A | *1 | *5 | *6 | 254 | 400 | Comp. |
| 3 | 1 | PVC | 45 | A | *1 | *5 | *6 | 254 | 400 | Comp. |
| 4 | 1 | Art | *4 | A | *1 | *5 | *6 | 254 | 400 | Comp. |
| | | Paper | | | | | | | | |
| 5 | 2 | *3 | 38 | A | *1 | *5 | *6 | 254 | 400 | Inv. |
| 6 | 2 | PET | 53 | A | *1 | *5 | *6 | 254 | 400 | Inv. |
| 7 | 2 | PVC | 45 | A | *1 | *5 | *6 | 254 | 400 | Inv. |
| 8 | 2 | Art | *4 | A | *1 | *5 | *6 | 254 | 400 | Inv. |
| | | Paper | | | | | | | | |
| 9 | 3 | *3 | 38 | A | *1 | *5 | *6 | 254 | 400 | Inv. |
| 10 | 3 | PET | 53 | A | *1 | *5 | *6 | 254 | 400 | Inv. |
| 11 | 3 | PVC | 45 | A | *1 | *5 | *6 | 254 | 400 | Inv. |
| 12 | 3 | Art | *4 | A | *1 | *5 | *6 | 254 | 400 | Inv. |
| | | Paper | | | | | | | | |
| 13 | 4 | *3 | 38 | B | *2 | *5 | *6 | 254 | 180 | Comp. |
| 14 | 4 | PET | 53 | B | *2 | *5 | *6 | 254 | 180 | Comp. |
| 15 | 4 | PVC | 45 | B | *2 | *5 | *6 | 254 | 180 | Comp. |
| 16 | 4 | Art | *4 | B | *2 | *5 | *6 | 254 | 180 | Comp. |
| | | Paper | | | | | | | | |
| 17 | 5 | *3 | 38 | B | *2 | *5 | *6 | 254 | 180 | Inv. |
| 18 | 5 | PET | 53 | B | *2 | *5 | *6 | 254 | 180 | Inv. |
| 19 | 5 | PVC | 45 | B | *2 | *5 | *6 | 254 | 180 | Inv. |
| 20 | 5 | Art | *4 | B | *2 | *5 | *6 | 254 | 180 | Inv. |
| | | Paper | | | | | | | | |
| 21 | 6 | *3 | 38 | B | *2 | *5 | *6 | 254 | 180 | Inv. |
| 22 | 6 | PET | 53 | B | *2 | *5 | *6 | 254 | 180 | Inv. |
| 23 | 6 | PVC | 45 | B | *2 | *5 | *6 | 254 | 180 | Inv. |
| 24 | 6 | Art | *4 | B | *2 | *5 | *6 | 254 | 180 | Inv. |
| | | Paper | | | | | | | | |
| 25 | 4 | *3 | 38 | B | *2 | *5 | *6 | 254 | 180 | Comp. |
| 26 | 4 | PET | 53 | B | *2 | *5 | *6 | 254 | 180 | Comp. |
| 27 | 4 | PVC | 45 | B | *2 | *5 | *6 | 254 | 180 | Comp. |
| 28 | 4 | Art | *4 | B | *2 | *5 | *6 | 254 | 180 | Comp. |
| | | Paper | | | | | | | | |
| 29 | 6 | *3 | 38 | B | *2 | *5 | *6 | 254 | 180 | Inv. |
| 30 | 6 | PET | 53 | B | *2 | *5 | *6 | 254 | 180 | Inv. |
| 31 | 6 | PVC | 45 | B | *2 | *5 | *6 | 254 | 180 | Inv. |
| 32 | 6 | Art | *4 | B | *2 | *5 | *6 | 254 | 180 | Inv. |
| | | Paper | | | | | | | | |

*1: both ends of the recording head (System of FIG. 1)
*2: downstream position in the recording material conveying direction (System of FIG. 2)
*3: OPP (Yupo FS)
*4: Absorptive Recording Material
*5: Linear Light Source
*6: after 0.1 second
Comp.: Comparative Example
Inv.: Present Invention

<<Evaluation of Ink-Jet Recording Images>>

Each of the images recorded employing the above image recording method was evaluated for each of the items below.

(Evaluation of Character Quality)

Ming-cho type characters at 6-point were printed at the target density, employing each color of Y, M, C, and K, and character quality was evaluated based on the criteria below.
A: no jaggedness was noted
B: slight jaggedness was noted
C: jaggedness was noted, but characters were readable and at the lower limit for commercial viability
D: marked jaggedness was noted and at such a level that characters were not readable due to blurring
   (Color Mixing (Bleeding and Wrinkling))

At 720 dpi, individual dots of each of the colors Y, M, C, and K were printed to be adjacent to each other, and each of the adjacent color dots was viewed via a hand held magnifying lens and the degree of bleeding was visually observed. The color mixing was evaluated based on the criteria below.
A: the shape of adjacent dots remained circular without bleeding
B: the shape of adjacent dots remained almost circular with almost no bleeding
C: adjacent dots exhibited slight bleeding and the dot shape was slightly deformed, but was at the lower limit of commercial viability
D: adjacent dots exhibited bleeding and mixing, and further, wrinkling was noted on the overlapped portions, and exhibited overall commercial non-viability

Table 8 shows each of the evaluation results.

TABLE 8

| | 10° C. at 20% RH | | 23° C. at 50% RH | | 27° C. at 80% RH | | |
|---|---|---|---|---|---|---|---|
| | | Color Mixing | | Color Mixing | | Color Mixing | |
| Sample | Character | (Bleeding | Character | (Bleeding | Character | (Bleeding | |
| No. | Quality | and Wrinkling) | Quality | and Wrinkling) | Quality | and Wrinkling) | Remarks |
| 1 | B | D | B | D | D | D | Comp. |
| 2 | B | D | B | D | C | D | Comp. |
| 3 | B | D | B | D | C | D | Comp. |
| 4 | B | D | B | D | D | D | Comp. |
| 5 | B | C | B | C | B | C | Inv. |
| 6 | B | B | B | B | B | B | Inv. |
| 7 | B | B | B | B | B | B | Inv. |
| 8 | C | B | C | B | C | B | Inv. |
| 9 | A | A | A | A | A | A | Inv. |
| 10 | A | A | A | A | B | B | Inv. |
| 11 | A | A | A | A | A | A | Inv. |
| 12 | A | A | A | A | B | B | Inv. |
| 13 | B | D | B | D | C | D | Comp. |
| 14 | A | D | A | C | C | C | Comp. |
| 15 | A | D | A | D | C | D | Comp. |
| 16 | B | D | B | C | C | C | Comp. |
| 17 | B | B | B | B | B | B | Inv. |
| 18 | B | A | B | A | B | A | Inv. |
| 19 | B | A | B | A | B | B | Inv. |
| 20 | B | B | B | B | B | B | Inv. |
| 21 | B | A | B | B | B | B | Inv. |
| 22 | A | A | A | A | A | A | Inv. |
| 23 | A | A | A | A | A | A | Inv. |
| 24 | A | B | B | B | B | B | Inv. |
| 25 | C | D | C | D | D | D | Comp. |
| 26 | B | D | B | D | C | D | Comp. |
| 27 | C | D | C | D | D | D | Comp. |
| 28 | D | D | D | D | D | D | Comp. |
| 29 | B | B | B | B | B | B | Inv. |
| 30 | B | A | B | A | B | B | Inv. |
| 31 | B | A | B | A | B | B | Inv. |
| 32 | B | B | B | B | B | B | Inv. |

Comp.: Comparative Example
Inv.: Present Invention

As is clearly seen from Table 8, by employing actinic radiation curable compositions containing the constitution according to the present invention, it is possible to record highly detailed images which exhibit excellent character quality and results in no formation of color mixing (no bleeding nor wrinkling) while employing any of the recording materials under various printing circumstances, compared to comparative examples.

1. An actinic ray curable ink composition, comprising:
(a) a photoinitiator; and
(b) a photopolymerizable compound,
wherein the photoinitiator is an onium compound exhibiting a hydrophobicity value (log P_{(O/W)}) of less than 1.0, P_{(O/W)} being a partition coefficient of the onium compound between 1-octanol and water.

2. The actinic ray curable ink composition of claim 1,
wherein the onium compound is a sulfonium salt.

3. The actinic ray curable ink composition of claim 1, further containing a basic compound.

4. The actinic ray curable ink composition of claim 1,
wherein the onium compound exhibits log P_{(O/W)} of less than 0.2.

5. The actinic ray curable ink composition of claim 1,
wherein the photopolymerizable compound is a compound having an oxetane group in the molecule.

6. The actinic ray curable ink composition of claim 1,
wherein the following photopolymerizable compounds are contained:
(i) a compound having an oxetane group in the molecule;
(ii) a compound having an oxirane group in the molecule; and
(iii) a vinyl ether compound,
an amount of (i), (ii) and (iii) each being respectively, 30 to 95 weight %, 5 to 70 weight %, and 0 to 40 weight % based on the total weight of the photopolymerizable compounds.

7. The actinic ray curable ink composition of claim 1,
wherein a viscosity of the ink composition at 25° C. is from 7 to 50 mP·s.

8. A method of forming an image comprising the steps of:
jetting droplets of the actinic ray curable ink composition of claim 1 from a plurality of nozzles of an ink-jet recording head onto a recording material to form an image; and
irradiating the formed image with actinic rays to cure the image,
wherein the irradiating step is carried out between 0.001 and 2.0 seconds after the jetted droplet of the ink composition reaches on the recording material.

9. A method of forming an image comprising the steps of:
jetting droplets of the actinic ray curable ink composition of claim 1 from a plurality of nozzles of an ink-jet recording head onto a recording material to form an image; and
irradiating the formed image with actinic rays to cure the image,
wherein the droplets of the actinic ray curable ink composition jetted from each nozzle of the ink-jet recording head have a volume of 2 to 20 pl.

10. A method of forming an image comprising the steps of:
jetting droplets of the actinic ray curable ink composition of claim 1 from a plurality of nozzles of an ink-jet recording head onto a recording material to form an image; and
irradiating the formed image with actinic rays to cure the image,
wherein the ink-jet head is a line-head.

11. An ink-jet recording apparatus for carrying out the image forming method of claim 8,
wherein the actinic ray curable ink composition and the ink-jet recording head are heated at 35 to 100° C. prior to jetting the actinic ray curable composition from a plurality of nozzles of the ink-jet recording head.
